(19) United States
(12) Patent Application Publication
(10) Pub. No.: US 2025/0145464 A1
(43) Pub. Date: May 8, 2025

(54) METHOD FOR PREPARING MESOPOROUS IRON PHOSPHATE BY INDUCTION OF BLOCK COPOLYMERS

(71) Applicant: YIDU XINGFA CHEMICAL CO., LTD, Yidu City, Yichang, Hubei (CN)

(72) Inventors: Jie WANG, Yidu City, Yichang, Hubei (CN); Baorui LUO, Yidu City, Yichang, Hubei (CN); Weiyun SHEN, Yidu City, Yichang, Hubei (CN); Chi ZHANG, Yidu City, Yichang, Hubei (CN); Lei ZHENG, Yidu City, Yichang, Hubei (CN); Haiquan TAN, Yidu City, Yichang, Hubei (CN); Zujing WANG, Yidu City, Yichang, Hubei (CN); Dong WANG, Yidu City, Yichang, Hubei (CN)

(73) Assignee: YIDU XINGFA CHEMICAL CO., LTD, Yidu City, Yichang, Hubei (CN)

(21) Appl. No.: 18/684,823

(22) PCT Filed: Apr. 21, 2023
(86) PCT No.: PCT/CN2023/089802

§ 371 Date: Feb. 19, 2024

(30) Foreign Application Priority Data
Aug. 3, 2022 (CN) 202210927570.X

(51) Int. Cl. C01B 25/37

(52) U.S. Cl. CPC C01B 25/375; C01P 2004/03; C01P 2004/51; C01P 2004/61; C01P 2006/12; C01P 2006/16; C01P 2006/40; C01P 2006/80

(57) ABSTRACT

A method for preparing mesoporous iron phosphate by induction of block copolymers is provided. The method comprises preparing a ferric salt solution having a certain concentration and evenly dispersing it into a dispersant, then evenly mixing a structure directing agent solution with a phosphorus source solution, next adding the mixed solution to the ferric salt solution while dropwise adding an oxidant and stirring to react, thus after ending the reaction, washing, drying and calcinating the reaction product to obtain mesoporous iron phosphate. It is achievable to treat the block copolymer acting as a structure directing agent by way of using diverse dispersants and acidifiers different in concentration and induce the disodium hydrogen phosphate dihydrate to react with ferric salt solution to prepare mesoporous iron phosphate, producing mesoporous iron phosphate with controllable different conformations and meeting the requirements of cathode materials for lithium-ion batteries in different application scenarios.

### FIELD

The present invention relates to the technical field of preparing iron phosphate materials, in particular to a method for preparing mesoporous iron phosphate by way of using a block copolymer to induce disodium hydrogen phosphate dihydrate brought as a by-product for producing glyphosate.

### BACKGROUND

Compared with three-phase materials, lithium iron phosphate serving as a cathode material for lithium batteries has obvious advantages such as high safety, long cycle life and low costs. In recent years, China's lithium iron phosphate industry has flourishingly developed and played a great role in promoting its new energy industry in its entirety. In terms of a lithium iron phosphate industry chain, the preparation of iron phosphate precursors is the key to production of lithium iron phosphate, for example, the production of 1 ton of lithium iron phosphate cathodes (carbon-thermal reduction) needs about 0.95 tons of iron phosphate precursors. The preparation of iron phosphate needs a phosphorus source and an iron source, and there are currently about two kinds of the phosphorus source, one derives from purified phosphoric acid, and the other derives from industrial-grade monoammonium phosphate. Varying with production processes of iron phosphate, the phosphorus source still accounts for the biggest proportion of raw material costs for iron phosphate, about 62% of the raw material costs, and accounts for about 35% of the total costs. As the prices of industrial purified phosphoric acid and industrial monoammonium continue to rise, the production costs of iron phosphate also confront great pressure.

Xingfa Group has production equipment capable of producing 130,000 tons of glyphosate and 60,000 tons of preparation per year, which will generate a large amount of mother liquor (crude brine) in the glyphosate production process. In the light of a calculation, 4.5 tons of crude brine will be derived from each production of 1 ton glyphosate, so 585,000 tons of crude brine will be produced per year following that production. At present, the company adopts equipment for pretreating crude brine such as oxidizing, crystallizing and filter-pressing the crude brine to obtain disodium hydrogen phosphate dodecahydrate, but in the actual production, there still exist problems such as of the disodium hydrogen phosphate dodecahydrate, the low active ingredient, the odor, and the low proportion of mixed solution used for producing industrial-grade phosphate, therefor the company has specially developed a new process of obtaining disodium hydrogen phosphate dihydrate by way of passing through denitrification and MVR evaporation and concentration again. The disodium hydrogen phosphate dihydrate can be used as a boiler water softener, used in tanning, as well as used as a weight gainer for fabrics, a flame retardant for wood and paper, chemicals for glazes and solders and the likes in traditional sense. In addition, it can be used as a stabilizer for bleaching with hydrogen peroxide in the printing and dyeing industry, a raw material for the manufacture of sodium pyrophosphate and other phosphates, and a culture agent for the products of monosodium glutamate, erythromycin, penicillin, streptomycin, biological wastewater treatment and so on.

Non-siliceous mesoporous inorganics, especially mesoporous phosphate (Sn, Ni, Ti, Fe, and V, etc.), have attracted great attention in the past few years because of their potential applications in catalysis, adsorption, separation, electronics and the likes, and among them the mesoporous iron phosphate has attracted great attention in both traditional chemical research and emerging applications in portable electronic devices and lithium-ion batteries. Controlling the conformation and mesoporous structure of mesoporous iron phosphate is crucial to improve the electrochemical performance of energy storage materials. Since an iron phosphate precursor is re-insoluble in an aqueous phosphate medium, it remains a complex problem to control both the conformation and the porous nanostructure for the material having a complex crystal structure such as iron phosphate. Self-organizing materials based on ionic surfactants having low molecular weight such as cetyltrimethylammonium bromide (CTAB) and sodium dodecyl sulfate (SDS) in an aqueous medium can adjust the structure of mesoscopic iron phosphate to a certain extent, but the pore wall of the obtained iron phosphate presents an amorphous conformation. That is, because ionic structure directing agents (SDAs) for self-organizing present poor structural stability in an aqueous medium, it is difficult to obtain a novel conformation having a mesoporous structure. In contrast, nonionic block copolymers are a kind of attracting SDAs due to the diversity of their self-organizing properties. Therefore, it is achievable to adjust the size and conformation of mesoporous iron phosphate by adjusting the solvent composition, molecular weight, and polymer masses.

Based on this, in order to raise the economic utilization value of disodium hydrogen phosphate dihydrate brought as a by-product for producing glyphosate, and improve the controllability of the conformation of iron phosphate materials and the electrochemical properties of derivatives, energy storage materials, the present invention uses a nonionic amphiphilic block copolymer as a structure directing agent in a non-aqueous medium, so as to prepare a novel crystalline mesoporous iron phosphate material having different conformations, for which it is achievable to obtain a uniform rod-shaped or layer-shaped mesoporous structure by way of adjusting the solvent composition in a synthesis medium to control the size and conformation of mesoporous iron phosphate, and enable the microstructure and conformation of the precursor to still remain after calcinating and crystallizing its pore wall.

### SUMMARY

In view of existence of a large amount of disodium hydrogen phosphate dihydrate brought as a by-product for producing glyphosate that have a low added value, and considering that the phosphorus source accounts for a big proportion of the production costs for iron phosphate, the present invention has developed a method for preparing iron phosphate by way of using disodium hydrogen phosphate dihydrate brought as a by-product for producing glyphosate, which innovatively use a block copolymer to achieve controllable adjustment to the size and conformation of mesoporous iron phosphate and can effectively solve the above two problems, exerting its advantage and avoiding its disadvantage to achieve a multipurpose. Specifically, the present invention relates to the preparation of controllable mesoporous iron phosphate by way of using a block copolymer to induce disodium hydrogen phosphate dihydrate brought as a by-product for producing glyphosate.

In order to achieve the above objective, the present invention provides the following technical solution of
preparing a ferric salt solution having a certain concentration and evenly dispersing it into a dispersant, then evenly mixing a structure directing agent solution with a phosphorus source solution, next adding the mixed solution to the ferric salt solution while dropwise adding an oxidant and stirring to react, thus after ending the reaction, washing, drying and calcinating the reaction product to obtain mesoporous iron phosphate.

The present invention provides a preferred solution that further defines the above-mentioned step as mixing the structure directing agent solution pressurized and atomized by an atomizer under an inert atmosphere with the phosphorus source solution, then adding the mixed solution into the dispersed ferric salt solution at a flow rate of 5-40 mL/min, and adding an oxidant while stirring to react, next washing, drying and calcinating the reaction product to obtain an iron phosphate product. The reaction progresses, so as to enable the molar ratio of Fe in the iron source, P in the phosphorus source and the oxidant to be 1:(1.0225-1.06):(1.16-1.3), and the mass of the structure directing agent solution to be added as 0.49-1 times of the mass of the phosphorus source. The dispersant used in the process of dispersing the ferric salt is any one of ethanol, tetrahydrofuran, chloroform, isopropanol and cyclohexane.

The iron source is ferrous sulfate brought as a by-product for producing titanium dioxide, of which ferrous sulfate heptahydrate accounts for 96.6-97.6%, magnesium sulfate heptahydrate accounts for 2.1-2.9%, and ferrous chloride accounts for 0.4-0.5%, by weight; after dissolving the ferrous sulfate brought as a by-product for producing titanium dioxide, its mixed solution Density is 1.1-1.3 g/cm³, and the temperature kept during heating and dissolving it is 50-80° C. (preferably 60-80° C.), thus an excess iron powder is added while stirring to react and adjust pH to be 2-5 (preferably 3-4). Then cationic polyacrylamide (CPAM) is added as a flocculant, which accounts for 0.01%-0.1% of the total mass of the solution, next the solution is stirred at a specific rate of 100 r/min for 10-20 min and then left motionlessly for 20-30 min.

The preparation method of the structure directing agent solution includes the step of adding an inorganic acid and a carboxylic acid derivative to a solvent to carry out carboxylation reaction, then adding a block copolymer, finally obtaining a product after stirring and fully dissolving. The solvent is any one of ethanol, tetrahydrofuran, chloroform, isopropanol and cyclohexane; the inorganic acid is a hydrochloric acid, a nitric acid or a sulfuric acid; the carboxylic acid derivative is a trimesic acid and/or a terephthalic acid; the block copolymer is F127 or P123.

The mass concentration of the inorganic acid is 15%-36%, and the acid is added as 0.05-0.12 times of the mass of the solvent.

During acidification, the acidification mass concentration of the inorganic acids is 15%, 20%, 30%, 32%, 34%, or 36%.

The carboxylic acid derivative is added as 0.1%-0.3% times of the mass of the solvent.

The block copolymer is added as 0.02-0.04 times of the mass of the solvent.

The phosphorus source of the present invention is disodium hydrogen phosphate dihydrate, phosphoric acid, diammonium hydrogen phosphate and ammonium dihydrogen phosphate, and the phosphorus source should be heated and dissolved at 30-50° C. in form of powder.

The oxidant is at least one of hydrogen peroxide, potassium peroxide and sodium peroxide, and the molar ratio of its added quantity to the molar quantity of ferric salt is 1.16-1.3.

The way of drying includes spray-drying or drying within 100° C.

The process of washing is executed with water, ethanol and isopropanol until the filtrate conductivity is ≤300 μs/cm.

The process of calcinating is executed at a low-temperature of 200-300° C. for 1-3 h and then at 480-560° C. for 1-3 h to obtain a mesoporous iron phosphate powder.

The present invention uses the ferrous sulfate brought as a by-product for producing titanium dioxide as an iron source to pioneeringly enable the disodium hydrogen phosphate dihydrate to act as a phosphorus source, and innovatively uses the block copolymer to achieve controllable adjustment to the size and conformation of mesoporous iron phosphate, so as to successfully synthesize mesoporous iron phosphate having adjustable two-dimensional (2D) and one-dimensional (1D) structures. The reaction process is simple and convenient and capable of making use of two industrial by-products at the same time and preparing anhydrous iron phosphate used as a lithium iron phosphate precursor, which is a part of a cathode material for a new energy lithium battery and has high added value and good environmental benefit. In addition, dehydrating is executed in form of a combination of low and high temperatures, so it is possible to reduce costs and improve production efficiency while fulfilling a dehydration rate.

The present invention has the following beneficial effects.

Compared with the prior art, the technical method of the present invention is novel and unique, and achievable to treat the block copolymer acting as a structure directing agent by way of using diverse dispersants and acidifiers different in concentration and induce the disodium hydrogen phosphate dihydrate to react with a ferric salt solution to prepare mesoporous iron phosphate, producing mesoporous iron phosphate with controllable different conformations and meeting the requirements of cathode materials for lithium-ion batteries in different application scenarios. Both the iron source and the phosphorus source acting as two main reactants in the reaction are industrial by-products, which can greatly reduce the production costs by way of simple impurity removal without pollution in the production process, and the prepared iron phosphate has high crystallinity and high tap density. Furthermore, the introduction of the disodium hydrogen phosphate dihydrate can optimize the company's production process and further create a closed-loop recycling economy model for the entire industry, which enables the stable supply of raw materials with assistance of improving the batch stability of iron phosphate materials, so it is of great practical significance for the industrial application of iron phosphate materials.

### BRIEF DESCRIPTION OF THE DRAWINGS

FIG. 1 is an electron scanning micrograph of the iron phosphate prepared in Example 1.

FIG. 2 is an electron scanning micrograph of the iron phosphate prepared in Example 1-1.

FIG. 3 is an electron scanning micrograph of the iron phosphate prepared in Example 1-2.

FIG. 4 is an electron scanning micrograph of the iron phosphate prepared in Example 2.

FIG. 5 is an electron scanning micrograph of the iron phosphate prepared in Example 2-1.

FIG. 6 is a flow chart of preparing iron phosphate.

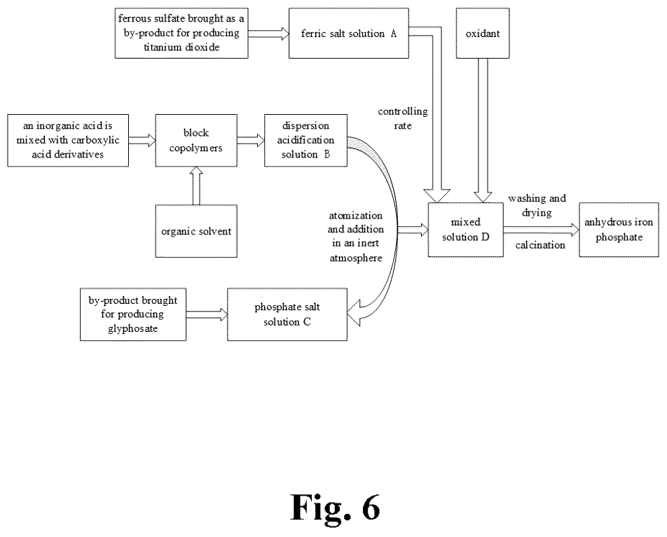

### DETAILED DESCRIPTION

We shall further explain the idea of the present invention as follows in combination with specific examples, but these examples are used only to describe the present invention, not used to impose a limitation on the scope protection of the present invention. It should be understood that, based on the content of the present invention, a person skilled in the art cam make various changes or modifications on the present invention, but this kind of equivalents also fall within the protection scope claimed by the present application.

The iron source used in the present invention is ferrous sulfate brought as a by-product for producing titanium dioxide, of which ferrous sulfate heptahydrate accounts for 96.6-97.6%, magnesium sulfate heptahydrate accounts for 2.1-2.9%, and ferrous chloride accounts for 0.4-0.5%, by weight; after dissolving the ferrous sulfate brought as a by-product for producing titanium dioxide, its mixed solution Density is 1.1-1.3 g/cm³.

### Example 1

Take 172.67 g of the ferrous sulfate brought as a by-product for producing titanium dioxide to dissolve in 500 mL deionized water, then heat the solution to 60° C., and add an excess iron powder and slowly stir the solution until its pH reaches 3.5, then filter out the excess iron powder, next add a cationic polyacrylamide (CPAM) flocculant accounting for 0.01% of the mass of the solution and slowly stir the solution for 15 min, after that leave it motionlessly for 30 min, and then filter out an deposition to obtain a ferrous sulfate solution A.

Take 500 g of ethanol as a dispersant, then dropwise add 30 g of hydrochloric acid having a mass fraction of 15% and 0.77 g of terephthalic acid for acidification, and add 10 g of block copolymer F127, then execute magnetic stirring for 2 h to fully dissolve them for reaction to obtain a solution B.

Take 106.8 g of the disodium hydrogen phosphate dihydrate brought as a by-product for producing glyphosate to add it into 300 mL deionized water, then heat the solution to 30° C. and stir it to completely dissolve the solute to obtain a solution C.

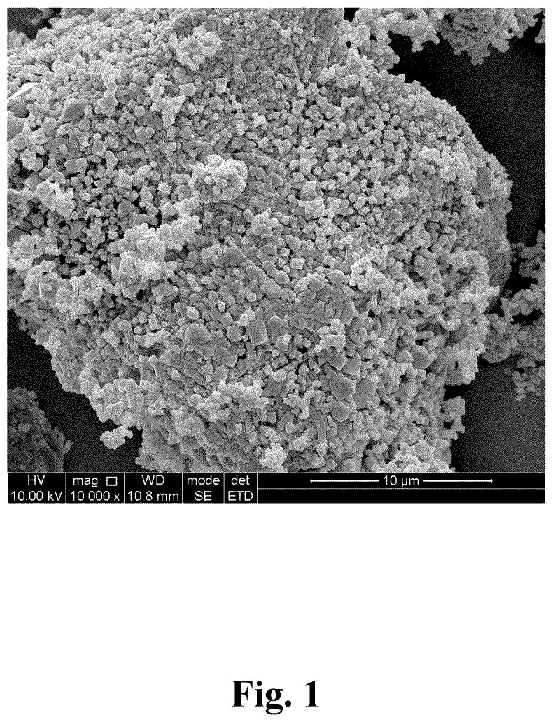

At the start of the reaction, add 228.2 g of ethanol to the entire solution A to disperse it evenly. Subsequently, quickly weigh 199.33 g of the solution B, then mix it with the entire solution C by way of spraying in form of atomization in a nitrogen atmosphere for 3.5 min, and then stir the solution to obtain a mixed solution D, next add the entire mixed solution D to the dispersed solution A at a rate of 5 mL/min, meanwhile slowly dropwise add 78.88 g of hydrogen peroxide having a mass fraction of 30% by means of a peristaltic pump to ensure that its addition concurrently finishes with the mixed solution D and keep continuing stirring during addition for 8 h, after finishing the reaction, alternately wash the solution with deionized water and ethanol until its filtrate conductivity reaches ≤300 μs/cm, then transfer the thick liquid obtained after that washing to a blast drying oven and dry it at 60° C. Transfer the material obtained after that drying to a muffle furnace and heat it at 3° C./min, thus calcinate it at a low temperature of 300° C. for 2 h, and then at 520° C. for 3 h to obtain an anhydrous iron phosphate powder. FIG. 1 is an electron scanning micrograph of the iron phosphate prepared in Example 1. The prepared iron phosphate particulates present an irregular structure with distributed cubical masses and have abundant porosity and good particulate dispersity.

### Example 1-1

The formula and step are the same as those in Example 1, except that tetrahydrofuran is used as a dispersant for the block copolymer in Example 1-1 in form of the same quantity as that for the block copolymer F127 in the dispersion step in Example 1.

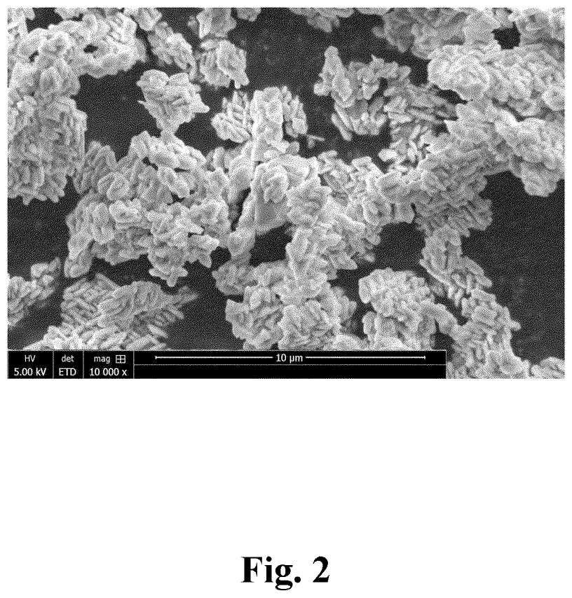

FIG. 2 is an electron scanning micrograph of the iron phosphate prepared in Example 1-1. The prepared iron phosphate particulates present a heterotypic spheroidal conformation or a rod-shaped distribution and have a good stereoscopic effect, and the particulates appear slightly agglomerate.

### Example 1-2

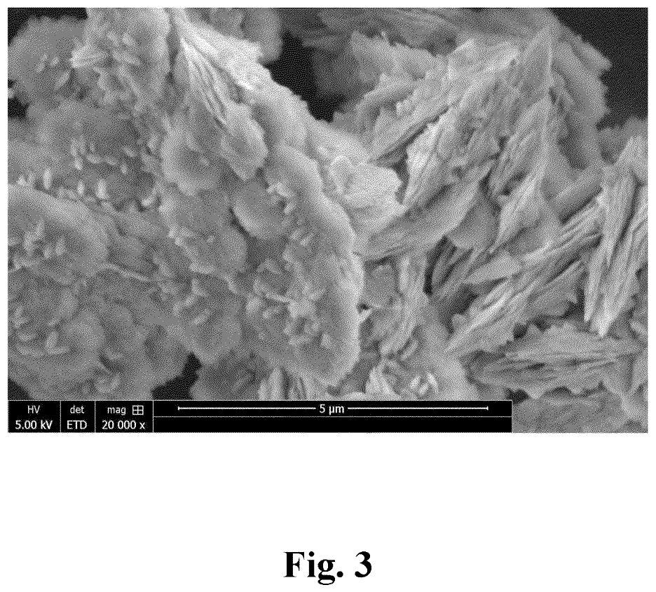

The formula and step are the same as those in Example 1, except that isopropanol is used as a dispersant for the block copolymer F127 in Example 1-2 in form of the same quantity as that for the block copolymer F127 in the dispersion and acidification steps in Example 1, meanwhile 57.75 g of 20% hydrochloric acid and 0.43 g of terephthalic acid are used for acidification. FIG. 3 is an electron scanning micrograph of the iron phosphate prepared in Example 1-2. The prepared iron phosphate particulates present a spindle-shaped cotton flock-like conformation and have good surface modification properties, thus modified and doped lithium iron phosphate materials could be prepared subsequently.

### Example 1-3

The formula and step are the same as those in Example 1, except that 38.5 g of 30% hydrochloric acid and 0.43 g of terephthalic acid are used for such an acidification step as that for the block copolymer F127 in Example 1.

### Example 1-4

The formula and step are the same as those in Example 1, except that 34 g of 34% hydrochloric acid and 0.43 g of terephthalic acid are used for such an acidification step as that for the block copolymer F127 in Example 1.

### Example 1-5

The formula and step are the same as those in Example 1, except that 33 g of 36% hydrochloric acid and 0.43 g of terephthalic acid are used for such an acidification step as that for the block copolymer F127 in Example 1.

### Example 2

Take 345.34 g of the ferrous sulfate brought as a by-product for producing titanium dioxide to dissolve in 1000 mL deionized water, execute the remaining steps same as in Example 1, thus obtain a ferrous sulfate solution A following impurity removal.

Take 500 g of ethanol as a dispersant, then dropwise add 77 g of hydrochloric acid having a mass fraction of 15% and 0.77 g of terephthalic acid for acidification, and add 15 g of block copolymer F123, then execute magnetic stirring for 2 h to fully dissolve them for reaction to obtain a solution B.

Take 213.6 g of the disodium hydrogen phosphate dihydrate brought as a by-product for producing glyphosate to add it into 500 mL deionized water, then heat the solution to 35° C. and stir it to completely dissolve the solute to obtain a solution C.

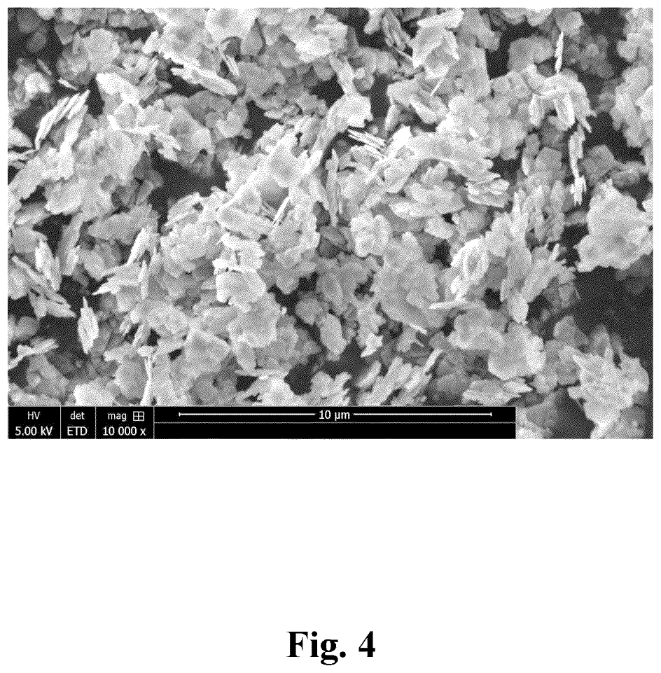

At the start of the reaction, add 456.4 g of ethanol to the entire solution A to disperse it evenly. Subsequently, quickly weigh 428.6 g of the solution B, then mix it with the entire solution C by way of spraying in form of atomization in a nitrogen atmosphere for 5 min, and then stir the solution to obtain a mixed solution D, next add the entire mixed solution D to the dispersed solution A at a rate of 8 mL/min, meanwhile slowly dropwise add 157.76 g of hydrogen peroxide having a mass fraction of 30% by means of a peristaltic pump to ensure that its addition concurrently finishes with the mixed solution D and keep continuing stirring during addition for 10 h, after finishing the reaction, alternately wash the solution with deionized water and ethanol until its filtrate conductivity reaches ≤300 μs/cm, then transfer the thick liquid obtained after that washing to a blast drying oven and dry it at 60° C. Transfer the material obtained after that drying to a muffle furnace and heat it at 3° C./min, thus calcinate it at a low temperature of 300° C. for 2 h, and then at 540° C. for 3 h to obtain an anhydrous iron phosphate powder. FIG. 4 is an electron scanning micrograph of the iron phosphate prepared in Example 2. The prepared iron phosphate particulates present an irregular flake-shaped conformation and have a good stereoscopic structure.

### Example 2-1

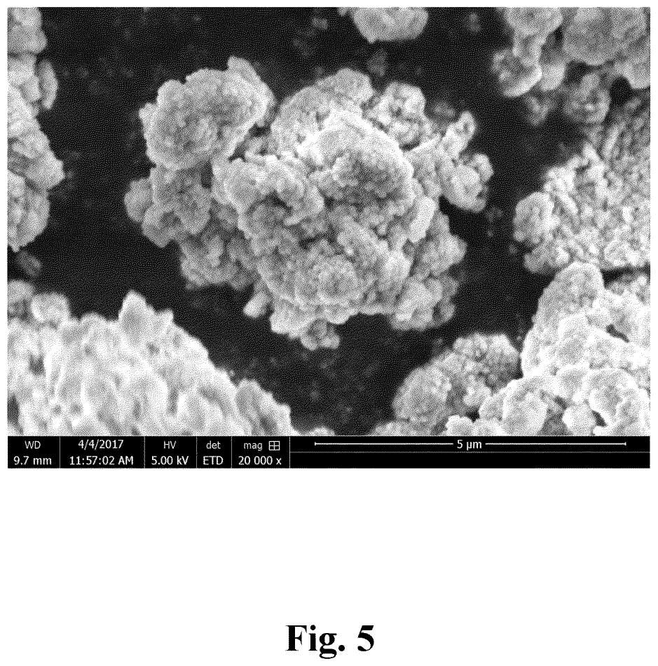

The formula and step are the same as those in Example 2, except that tetrahydrofuran is used as a dispersant for the block copolymer in Example 2-1 in form of the same quantity as that for the block copolymer F123 in the dispersion step in Example 2. FIG. 5 is an electron scanning micrograph of the iron phosphate prepared in Example 2-1. The prepared iron phosphate particulates present small-globular primary particulate agglomerates irregularly stacked.

### Example 2-2

The formula and step are the same as those in Example 2, except that cyclohexane is used as a dispersant for the block copolymer F123 in Example 2-1 in form of the same quantity as that for the block copolymer F123 in the dispersion step in Example 2.

### Example 2-3

The formula and step are the same as those in Example 2, except that isopropanol is used as a dispersant for the block copolymer F123 in Example 2-3 in form of the same quantity as that for the block copolymer F123 in the dispersion and acidification steps in Example 2, meanwhile 57.75 g of 20% hydrochloric acid and 0.43 g of terephthalic acid are used for acidification.

### Example 2-4

The formula and step are the same as those in Example 2, except that isopropanol is used as a dispersant for the block copolymer F123 in Example 2-4 in form of the same quantity as that for the block copolymer F123 in the dispersion and acidification steps in Example 2, meanwhile 57.75 g of 20% hydrochloric acid and 0.61 g of trimesic acid are used for acidification.

### Example 2-5

The formula and step are the same as those in Example 2, except that ethanol is used as a dispersant for the block copolymer F123 in Example 2-5 in form of the same quantity as that for the block copolymer F123 in the dispersion and acidification steps in Example 2, meanwhile 38.5 g of 30% hydrochloric acid and 0.39 g of trimesic acid are used for acidification.

### Example 2-6

The formula and step are the same as those in Example 2, except that ethanol is used as a dispersant for the block copolymer F123 in Example 2-6 in form of the same quantity as that for the block copolymer F123 in the dispersion and acidification steps in Example 2, meanwhile 33.9 g of 34% hydrochloric acid and 0.27 g of trimesic acid are used for acidification.

### Example 3

Take 172.67 g of the ferrous sulfate brought as a by-product for producing titanium dioxide to dissolve in 500 mL deionized water, then heat the solution to 80° C., and add an excess iron powder and slowly stir the solution until its pH reaches 4, then filter out the excess iron powder, next add a flocculant accounting for 0.08% of the mass of the solution and slowly stir the solution for 20 min, after that leave it motionlessly for 30 min, and then filter out an deposition to obtain a ferrous sulfate solution A.

The preparation of the solution B is the same as that in Example 1.

Take 106.8 g of the disodium hydrogen phosphate dihydrate brought as a by-product for producing glyphosate to add it into 300 mL deionized water, then heat the solution to 30° C. and stir it to completely dissolve the solute to obtain a solution C.

At the start of the reaction, add 228.2 g of tetrahydrofuran to the entire solution A to disperse it evenly. Subsequently, quickly weigh 199.33 g of the solution B, then mix it with the entire solution C by way of spraying in form of atomization in a nitrogen atmosphere for 4 min, and then stir the solution to obtain a mixed solution D, next add the entire mixed solution D to the dispersed solution A at a rate of 10 mL/min, meanwhile slowly dropwise add 78.88 g of hydrogen peroxide having a mass fraction of 30% by means of a peristaltic pump to ensure that its addition concurrently finishes with the mixed solution D and keep continuing stirring during addition for 10 h, after finishing the reaction, alternately wash the solution with deionized water and ethanol until its filtrate conductivity reaches ≤300 μs/cm, then transfer the thick liquid obtained after that washing to a blast drying oven and dry it at 80° C. Transfer the material obtained after that drying to a muffle furnace and heat it at 3° C./min, thus calcinate it at a low temperature of 300° C. for 3 h, and then at 520° C. for 3 h to obtain an anhydrous iron phosphate powder.

### Example 3-1

The formula and step are the same as those in Example 3, but the reaction processes in both examples are different from each other in the rate control mode. The solution B is mixed with the solution C by way of spraying in form of atomization for 30 min, then the mixed solution is added into the dispersed solution A at a rate of 10 mL/min.

### Example 3-2

The formula and step are the same as those in Example 3, but the reaction processes in both examples are different from each other in the rate control mode. The solution B is mixed with the solution C by way of spraying in form of atomization for 30 min, then the mixed solution is added into the dispersed solution A at a rate of 20 mL/min.

### Example 3-3

The formula and step are the same as those in Example 3, but the reaction processes in both examples are different from each other in the rate control mode. The solution B is mixed with the solution C by way of spraying in form of atomization for 30 min, then the mixed solution is added into the dispersed solution A at a rate of 30 mL/min.

### Example 3-4

The formula and step are the same as those in Example 3, but the reaction processes in both examples are different from each other in the rate control mode. The solution B is mixed with the solution C by way of spraying in form of atomization for 30 min, then the mixed solution is added into the dispersed solution A at a rate of 40 mL/min.

TABLE 1
Index comparison of anhydrous iron phosphate prepared in the examples

| | | | | | | | | average | specific |
|---|---|---|---|---|---|---|---|---|---|
| | | | | | | | | pore | surface |
| | Fe | P | | particle diameter (um) | | | | diameter | area |
| | (%) | (%) | Fe:P | D10 | D50 | D90 | D100 | (nm) | (m²/g) |
| Example 1 | 36.38 | 20.47 | 0.9855 | 1.22 | 3.76 | 45.36 | 78.89 | 5.66 | 7.4938 |
| Example1-1 | 36.18 | 20.56 | 0.9758 | 1.09 | 4.55 | 55.32 | 90.23 | 5.73 | 11.6814 |
| Example1-2 | 36.86 | 20.56 | 0.9941 | 1.11 | 4.96 | 39.47 | 66.54 | 6.35 | 10.2939 |
| Example1-3 | 36.30 | 20.51 | 0.9814 | 0.95 | 3.23 | 44.65 | 86.36 | 5.62 | 11.6502 |
| Example1-4 | 36.22 | 20.54 | 0.9778 | 0.78 | 3.35 | 65.23 | 101.21 | 5.56 | 12.0066 |
| Example1-5 | 36.35 | 20.31 | 0.9924 | 0.82 | 3.83 | 60.90 | 117.89 | 6.99 | 8.3733 |
| Example 2 | 36.27 | 20.39 | 0.9864 | 0.35 | 3.32 | 56.32 | 98.36 | 5.39 | 9.6994 |
| Example2-1 | 36.04 | 20.41 | 0.9791 | 0.38 | 3.32 | 55.78 | 102.67 | 5.46 | 8.8756 |
| Example2-2 | 36.36 | 20.67 | 0.9754 | 0.55 | 3.55 | 80.21 | 146.32 | 5.28 | 8.8596 |
| Example2-3 | 36.14 | 20.65 | 0.9704 | 0.42 | 4.12 | 77.23 | 132.59 | 6.01 | 7.7447 |
| Example2-4 | 36.22 | 20.61 | 0.9745 | 0.36 | 4.06 | 58.94 | 96.38 | 7.03 | 10.2176 |
| Example2-5 | 35.96 | 20.52 | 0.9717 | 0.61 | 5.22 | 69.56 | 109.61 | 5.26 | 10.7629 |
| Example2-6 | 36.19 | 20.46 | 0.9808 | 0.39 | 5.19 | 71.69 | 159.27 | 5.89 | 8.4920 |
| Example 3 | 36.43 | 20.55 | 0.9830 | 0.85 | 5.56 | 67.61 | 132.59 | 5.17 | 9.6168 |
| Example3-1 | 36.33 | 20.63 | 0.9765 | 0.92 | 5.09 | 73.59 | 118.92 | 5.37 | 10.8684 |
| Example3-2 | 36.20 | 20.37 | 0.9854 | 1.02 | 5.28 | 76.99 | 170.23 | 6.19 | 10.9445 |
| Example3-3 | 36.24 | 20.59 | 0.9760 | 1.13 | 5.37 | 68.24 | 139.34 | 5.13 | 10.0985 |
| Example3-4 | 36.29 | 20.40 | 0.9864 | 0.98 | 5.16 | 80.16 | 159.29 | 5.94 | 10.4442 |

What is claimed is:

1. A method for preparing mesoporous iron phosphate by induction of block copolymers, comprising the steps of: preparing a ferric salt solution having a certain concentration and evenly dispersing it into a dispersant, then evenly mixing a structure directing agent solution with a phosphorus source solution, next adding the mixed solution to the ferric salt solution while dropwise adding an oxidant and stirring to react, after the reaction, washing, drying and calcinating a reaction product to obtain mesoporous iron phosphate.

2. The method for preparing mesoporous iron phosphate by induction of block copolymers according to claim 1, wherein the structure directing agent solution is pressurized and atomized by an atomizer under an inert atmosphere, and is mixed with the phosphorus source solution, then the mixed solution is added into the dispersed ferric salt solution at a flow rate of 5-40 ml/min.

3. The method for preparing mesoporous iron phosphate by induction of block copolymers according to claim 2, wherein, the reaction progresses, so as to enable a molar ratio of Fe in an iron source, P in the phosphorus source and the oxidant to be 1:(1.0225-1.06):(1.16-1.3), and a mass of the structure directing agent solution to be added as 0.49-1 times of a mass of the phosphorus source.

4. The method for preparing mesoporous iron phosphate by induction of block copolymers according to claim 3, wherein the iron source is ferrous sulfate brought as a by-product for producing titanium dioxide, of which ferrous sulfate heptahydrate accounts for 96.6-97.6%, magnesium sulfate heptahydrate accounts for 2.1-2.9%, and ferrous chloride accounts for 0.4-0.5%, by weight; after dissolving the ferrous sulfate brought as a by-product for producing titanium dioxide, its solution density is 1.1-1.3 g/cm³.

5. The method for preparing mesoporous iron phosphate by induction of block copolymers according to claim 1, wherein the ferric salt is heated to 50-80° C., then an excess iron powder is added and is stirred to react and pH is adjusted to be 2-5, next a 0.01 wt %-0.1 wt % cationic flocculant is added, and the solution is stirred evenly, and then is left to stand for deposition, finally the ferric salt solution of ferrous sulfate is obtained via filtration.

6. The method for preparing mesoporous iron phosphate by induction of block copolymers according to claim 1, wherein the dispersant used is selected from the group consisting of ethanol, tetrahydrofuran, chloroform, isopropanol and cyclohexane.

7. The method for preparing mesoporous iron phosphate by induction of block copolymers according to claim 1, wherein a preparation method of the structure directing agent solution comprises the steps of adding an inorganic acid and a carboxylic acid derivative to a solvent to carry out carboxylation reaction, then adding a block copolymer, finally obtaining a product after stirring and fully dissolving;
the solvent is ethanol, tetrahydrofuran, chloroform, isopropanol or cyclohexane; the inorganic acid is a hydrochloric acid, a nitric acid or a sulfuric acid; the carboxylic acid derivative is a trimesic acid and/or a terephthalic acid; the block copolymer is F127 or P123;
a mass concentration of the inorganic acid is 15%-36%, and the acid is added as 0.05-0.12 times of a mass of the solvent;
the carboxylic acid derivative is added as 0.1%-0.3% times of the mass of the solvent;
the block copolymer is added as 0.02-0.04 times of the mass of the solvent.

8. The method for preparing mesoporous iron phosphate by induction of block copolymers according to claim 1, wherein the phosphorus source is disodium hydrogen phosphate dihydrate, phosphoric acid, diammonium hydrogen phosphate or ammonium dihydrogen phosphate;
the oxidant is at least one of hydrogen peroxide, potassium peroxide and sodium peroxide, and a molar ratio of its added quantity to a molar quantity of ferric salt is 1.16-1.3.

9. The method for preparing mesoporous iron phosphate by induction of block copolymers according to claim 1, wherein a method of drying comprises spray-drying or drying within 100° C.;
a process of washing is executed with water, ethanol and isopropanol until filtrate conductivity is ≤300 μs/cm.

10. The method for preparing mesoporous iron phosphate by induction of block copolymers according to claim 1, wherein a process of calcinating is executed at a low-temperature of 200-300° C. for 1-3 h and then at 480-560° C. for 1-3 h to obtain a mesoporous iron phosphate powder.
